(19) United States
(12) Patent Application Publication
(10) Pub. No.: US 2002/0143633 A1
(43) Pub. Date: Oct. 3, 2002

(54) Point of purchase information and marketing tool and method

(76) Inventor: Lawrence Kunstadt, Ardsley, NY (US)

Correspondence Address: ST. ONGE STEWARD JOHNSTON & REENS, LLC, 986 BEDFORD STREET, STAMFORD, CT, 06905-5619, US

(21) Appl. No.: 09/824,479

(22) Filed: Apr. 2, 2001

(51) Int. Cl. G06F 17/60

(52) U.S. Cl. 705/16

(57) ABSTRACT

According to one embodiment of the invention a system for customer and manufacturer interaction is provided. The system includes a customer interface connected to a network and a manufacturer interface connected to the network, which is accessible by the customer interface. The customer interface and the manufacturer interface are operable to exchange information on a real-time basis, and the customer interface is located at a point of purchase for a good or service provided by the manufacturer.

### FIELD OF THE INVENTION

The present invention relates generally to a system and method for improving marketing support between manufacturers and customers. More specifically, the present invention provides a system and method for direct interaction between one or more manufacturers or manufacturers' representatives and a customer or group of customers at a point of purchase (i.e., at a retail location).

### BACKGROUND OF THE INVENTION

Present point of purchase systems for providing information to a potential or actual customer include video tape systems that provide the customer with an audio/visual message related to a particular product or products. The products may be those of a given retailer, a distributor or a manufacturer, and may be derived from one or more product lines or family of products. The marketing interaction between the customer and the video tape system is typically limited to the customer viewing and listening to the tape, which is usually not under the customer's control. The tape is typically limited in duration, and may be cyclical to repeat the information periodically. These limitations on use of the video tape system are typically provided to deliver the most pertinent or frequently requested information to the customer in the shortest time possible or to provide a description of product features and advantages.

A disadvantage of this type of system is that the information shown is chosen by the manufacturer, not the customer, and comprises a sales document. As such, the customer often will not receive the information he/she desires regarding a product, or will have further questions that can not be answered by the video tape system. Moreover, the video tape cannot be customized to the specific needs of the customer, since the specific needs of the customer are not known at the time the video tape is made. Further, the video tape cannot interact with the customer, and for example, customize an offer in order to consummate a sale. A further disadvantage is that this type of system cannot collect demographic information from the customer, which information is typically valuable to the seller.

Another typical method of supplying point of purchase information to a customer is to provide a sales or marketing representative at a retail location to answer customer inquiries, provide specific product information, and/or to hand out samples where appropriate, such as, for example, in the cases of perfumes or foods, which must be sampled and cannot readily be described. Often, these types of interactions with a customer are provided in conjunction with sales or promotional offers to increase the sales and marketing impact of the representation. However, it is not always possible to provide a representative of a product line or group of products when customers desire point of purchase information or to have targeted inquiries for a specific product. In addition, the representative typically represents only a specific manufacturer, distributor or retailer at any given time. If a customer has inquiries related to products not within the domain of the representative, the representative may be of no help, or may try to encourage the customer to obtain a product which the customer did not originally wish to purchase. Furthermore, this method is expensive and inefficient in that a large number of representatives must be hired because each one can only service the one location at which he/she is physically present, and in that each representative may spend a large amount of time idle while waiting for customers. Moreover, skilled and knowledgeable personnel are typically costly to hire and are therefore only hired for certain product types, such as complex products or big ticket items, and unskilled personnel are typically only effective to answer very general questions or to provide samples.

Another type of point of purchase marketing and sales approach to increase customer product awareness is to have in-store assistants provide information or answer questions related to products. The assistants are typically clerks employed by a retailer rather than professional sales and marketing persons. The assistants typically do not have specific knowledge on a given manufacturer's products, and are not motivated to drive a sale for a particular product, or on behalf of a particular manufacturer.

A customer can usually access information about particular products through various media not located at the point of purchase. For example, a customer may call an 800 number to speak with a sales representative who can answer questions about a product, or may take advantage of an Internet connection that permits the customer to access an informational web site. In the latter case, the customer can navigate the site to locate information of particular interest or view product information, including pictures, video and audio information, or the customer may initiate an email, text-based or video conferencing session with a representative. However these media are limited in that the consumer must visit the various manufacturers' websites and gather information manufacturer by manufacturer. Moreover, the customer is only able to evaluate one manufacturer's products, and cannot compare the products of different manufacturers. Furthermore, the customer experience is not at the point of purchase, and the customer must attempt to locate the desired information on the web site.

As with other methods described above, the web site may not provide specific information which the customer desires, and the customer has no interactive experience with a sales or marketing representative. In addition, the customer interested in products made by several different manufacturers must visit several different web sites to obtain desired information. Typically, the web sites will not be structured similarly, and the customer must educate himself/herself on navigation of the particular web site to obtain the desired information. Moreover, each site may provide different information making it difficult for the customer to effectively compare the products of different manufacturers. For example, websites typically do not provide prices, which may vary from retail store to retail store. Furthermore, a web site provided by a retailer or distributor may provide products by a number of manufacturers, but again the information is not typically responsive to specific customer requests and is not interactive.

Another medium that can be used to provide specific information to a customer is electronic messaging. Electronic messaging can take the form of email or other more interactive communications, such as instant messaging or electronic chat. This type of medium can offer interaction between the customer and the sales or marketing representative, and the representative is able to respond to specific inquiries by the customer. The representative can also deliver electronic information including pictures, audio and video information related to products about which the customer wishes to become informed.

Again, however, this medium is not available at a point of purchase, and does not permit a customer to easily acquire information regarding a number of different products, or products made by different manufacturers. For example, the customer would have to initiate several different electronic chat sessions to get information about several different manufacturers' products. In addition, this type of communication is typically unavailable from a number of manufacturers, retailers and distributors. In the case of communication by email, the customer may have to wait several hours or days to obtain a response to an inquiry, and may not be easily able to submit a secondary question, prompted by the first response. In this regard, such a system is similar to requesting product information by mail.

Also, a typical customer is not expected to be well versed in the use of electronic communication, typically requiring a fair amount of facility with a computer, such as a personal computer (PC). It is also expected that some customers seeking assistance through an electronic communication medium may become frustrated if they are not easily able to use the technology, interact with a live person or obtain the information they desire.

What is desired, therefore, is a system and method for improving marketing support which is located at the point of purchase, which is simple to use, which can deliver specific information chosen by a customer, which delivers desired information promptly to the customer, which provide for interaction between the manufacturer and customer, which can be used to collect demographic information from the customer, which is relatively inexpensive and efficient, which can provide information relating to a plurality of manufacturers' products, which allows negotiations between a customer and a manufacturer, and which allows for sales to be consummated, at the point of sale, and which allows for products of various manufacturers to be compared.

### SUMMARY OF THE INVENTION

Accordingly, the present invention seeks to overcome the drawbacks of the state of the art as presented above. It is thus an object of the present invention to provide a customer and sales or marketing representative interaction facility that is available at a point of purchase and that represents a plurality of manufacturers of the same type of products.

Briefly stated, there is provided according to the present invention a customer interaction directly with a manufacturer at a point of purchase through a wired or wireless network connecting a multi-media station or stations at the customer's location (i.e., a retail store) and at a manufacturer's location, such as a call center. It should be understood that when the term manufacturer is used herein and in the claims that follow, the term is meant to encompass manufacturers and their representatives, such as call center representatives, technical representatives, sales and marketing representatives, and the like. A manufacturer's representative provides pertinent information to the customer regarding products or services over the network in a media rich environment. The manufacturer's representative can be located remotely and can provide the customer with various audio and visual information relative to the customer's inquiry or knowledge about goods or services provided by the manufacturer. The manufacturer's representative can also interact with the customer and provide incentives (i.e., discounts, coupons, etc.) to the customer, or collect demographic information from the customer. The customer shopping experience is enhanced, while manufacturers are forced to be more competitive. The customer becomes better informed about various goods and services provided by competing manufacturers while in the store, thereby obviating the need for customers to investigate and study competing products before visiting the store. In addition, the customer can be offered various promotions at the point of purchase to improve vendor sales. Manufacturers can also obtain particular customer information for further marketing or sales efforts or to better understand customer demographics.

According to one embodiment of the invention a system for customer and manufacturer interaction is provided. The system includes a customer interface connected to a network and a manufacturer interface connected to the network, which is accessible by the customer interface. The customer interface and the manufacturer interface are operable to exchange information on a real-time basis, and the customer interface is located at a point of purchase for a good or service provided by the manufacturer.

Preferably, the customer interface and the manufacturer interface are operable to exchange information through a plurality of input and output devices. Also, the point of purchase is preferably a retail location offering the manufacturer's good or service, although such is not required, and the point of purchase may comprise, for example, a trade show, or the purchasing office of an institution such as a hospital, a college, or a business environment. It is also preferable that the customer interface and the manufacturer interface are operable to exchange information in a plurality of media types, which most preferably include audio, graphical, video and textual media formats.

Preferably, a manufacturer's representative is available at the manufacturer interface, and the manufacturer's representative provides information to the customer interface thereby presenting the customer with targeted information. It is also preferable that the manufacturer's representative receives information from the customer interface thereby providing the manufacturer with demographic information and allowing the manufacturer's representative to customize the information provided to the customer. Also, preferably the customer can select manufacturer or product information to be received via the customer interface.

The network may comprise a world-wide network of interconnected computers, a local area network (LAN) of interconnected computers, a wide area network (WAN) of interconnected computers, or a virtual private network (VPN) of interconnected computers. Most preferably, the network is accessible only by a set of specified manufacturers and a set of specified retailers.

According to another embodiment of the present invention, a system for customer and manufacturer interaction includes a customer interface connected to a network, the customer interface being located at a point of purchase for a good or service provided by the manufacturer, and a manufacturer interface connected to the network. Software executing on the customer interface receives an indication from the customer of a good or service category of interest chosen by the user, and displays a list of manufacturers offering goods or services within the good or service category of interest. Software executing on the customer interface also receives an indication from the customer of at least one manufacturer of interest chosen by the user, and establishes a real-time communication link between the customer interface and the manufacturer interface of the chosen manufacturer.

Preferably, software is also provided executing on the customer interface for receiving an indication of customer preferences, and for customizing the list of manufacturers based upon the indication of customer preferences. This allows the list of manufacturers to be customized in order to display only manufacturers offering products which meet the specified preferences of the customer. It is also preferable that a manufacturer's representative is available at the manufacturer interface, and that the manufacturer's representative be able to provide information to the customer interface thereby presenting the customer with targeted information. Preferably, the manufacturer's representative also receives information from the customer interface thereby providing the manufacturer with demographic information and allowing the manufacturer's representative to customize the information provided to the customer.

The invention and its particular features and advantages will become more apparent from the following detailed description considered with reference to the accompanying drawings.

### BRIEF DESCRIPTION OF THE DRAWINGS

FIG. 1 is a block diagram illustrating operation of one preferred embodiment of a system for improving marketing support between manufacturers and customers according to the present invention;

FIG. 2 is a connectivity block diagram of the invention shown in FIG. 1;

FIG. 3 is a block diagram of system architecture of the system for improving marketing support between manufacturers and customers according to the invention shown in FIG. 2;

FIG. 4 is a block diagram showing interaction mechanisms between individuals according to the invention shown in FIG. 2; and

FIG. 5 is a layout schematic of an interface according to the invention shown in FIG. 2.

### DETAILED DESCRIPTION OF THE INVENTION

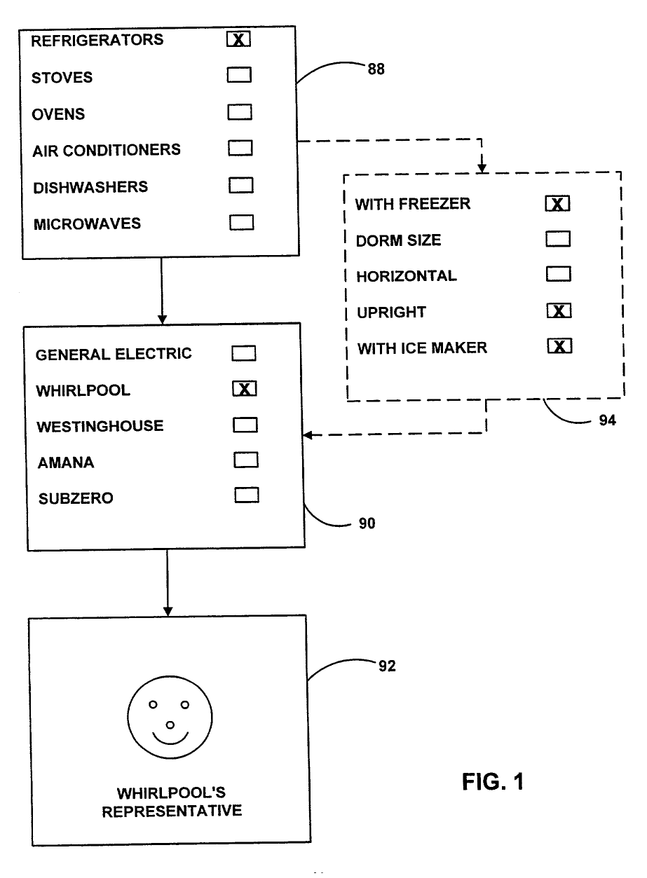

Referring first to FIG. 1, a block diagram illustrating operation of one preferred embodiment of system 10 is shown. In this embodiment, the customer has chosen to view product categories, which are displayed on a screen 88. For example, if system 10 is being operated in an appliance store, product categories may comprise refrigerators, stoves, ovens, air conditioners, dishwashers, microwaves, and the like. In the example illustrated in FIG. 1, the customer has chosen refrigerators by, for example, touching the appropriate location on a touch screen, using a mouse, or the like.

In response to the customer's choice, system 10 then displays a screen 90 including all manufacturers which have representatives available through system 10, and which offer products at the point of purchase within the category selected by the customer (refrigerators in this case). Examples of such manufacturers may include General Electric, Whirlpool, Westinghouse, Amana, Subzero and the like. The customer may choose one or more of the manufacturers from the list to initiate a communication link with representatives thereof. In the example shown in FIG. 1, the customer has chosen Whirlpool by, for example, touching the appropriate location on a touch screen, using a mouse, or the like. It should be understood, and as discussed above with respect to FIG. 1, the customer is preferably able to select more than one manufacturer from the list to initiate two or more communication links sequentially or simultaneously, although such is not required.

Once the customer has indicated a desired manufacturer, a communication link is open with a representative of the selected manufacturer (Whirlpool in this case), and communications between the customer and the manufacturer's representative can take place on screen 92 as discussed above.

System 10 may optionally allow the customer to further narrow the parameters of his/her interest by, for example, displaying one or more preference screens. Following the above example, after the customer indicates a desire to obtain information about refrigerators, system 10 may display to the customer one or more optional screens containing further selectable preferences. For example, screen 94 may be displayed which includes features relating to refrigerators, such as whether the customer desired a refrigerator which includes a freezer, whether the customer desires a dorm sized refrigerator, whether the customer desires a horizontal or an upright refrigerator, whether the customer desires a refrigerator which includes a freezer, and so on. The customer may select one or more of these features in order to narrow the list of manufacturers to only those offering products including the desired features. For example, as shown in FIG. 1, the customer has expressed a desire to obtain information relating to an upright refrigerator which includes a freezer and an ice maker. Only those manufacturers which offer such refrigerators will be displayed in the list on screen 90. Suppose for example, General Electric, Whirlpool and Westinghouse offered such refrigerators, while Amana and Subzero did not. The list displayed at screen 90 would include only General Electric, Whirlpool and Westinghouse, so that the customer would not waste time initiating a communication link with manufacturers (i.e., Amana and Subzero) which did not offer the products in which the customer was interested.

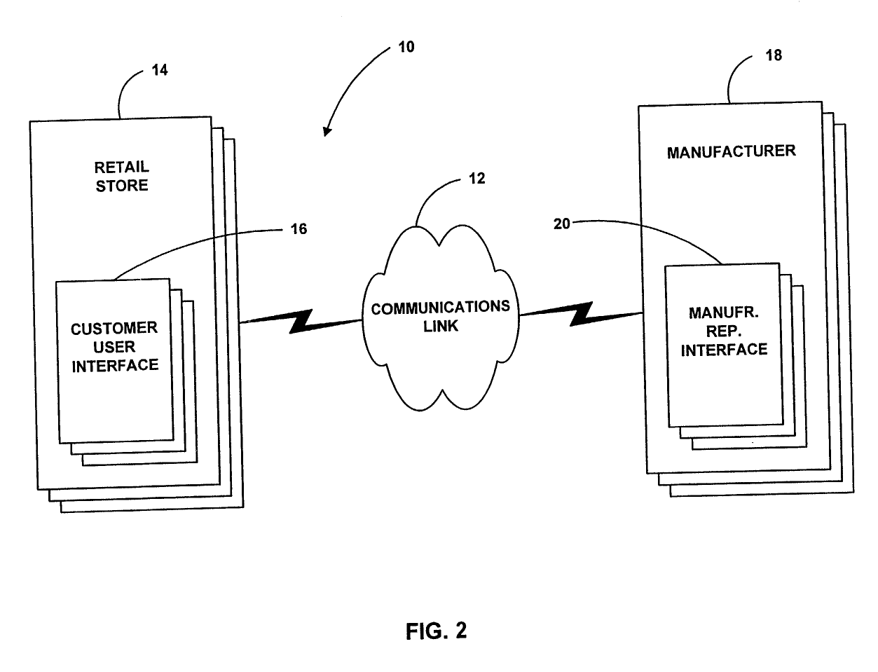

Referring now to FIG. 2, a connectivity diagram for a system 10 for improving marketing support between manufacturers and customers in accordance with the present invention is shown. A communications link 12 provides connectivity between the various components of system 10 to permit the components to interact electronically.

System 10 permits customers and manufacturer sales or marketing representatives to interact through connections provided to communications link 12, preferably while the customer is at a point of purchase 14, such as a retail store location. It should be noted that sales need not be limited to goods, but can include services as well. Accordingly, customers need not be located at, for instance, a retail store to interact with sales and marketing representatives through communications link 12. For example, customers may wish to obtain on-line help with a service at the point where the service may be contracted, such as at a trade show. However, it should be understood that the customer is located at a point of purchase 14, and not for instance, at his/her home.

Customers need not necessarily be purchasing goods or services when obtaining access to sales or marketing representatives through communications link 12. In addition, sales and marketing representatives may provide customers with assistance regarding items not traditionally classified as goods or services, such as financial management and planning.

Communications link 12 may comprise any type of communications link, either wired or wireless, such as, for example, the Internet, a local area network (LAN), a wide area network (WAN), a direct modem link, a virtual private network (VPN), or the like. It should be understood that when the term “network” is used herein and in the claims, what is meant is any means, whether wired or wireless, by which a signal may be transmitted from one device to another.

Customer user interfaces 16 are located at various points of purchase 14, for example, user interfaces 16 could be located at a retail store or a location where services may be contracted, and are connected to communications link 12. A plurality of customer user interfaces 16 may be located at a single point of purchase 14, for example, in different departments of a store, or only a single customer user interface 16 may be present.

Manufacturers 18 are connected to communications link 12 and provide representatives at manufacturer's representative interfaces 20 with access to customers at user interfaces 16 through communications link 12. It should be understood that when the term manufacturer is used herein and in the claims that follow, the term is meant to encompass manufacturers and their representatives, such as call center representatives, technical representatives, sales and marketing representatives, and the like. It should also be understood that a plurality of manufacturers 18 are connected to communications link 10, and that each manufacturer 18 may have a plurality of manufacturer's representative interfaces 20. This allows for customers to compare the products or services of multiple manufacturers 18, as described more fully below.

A customer has access to communications link 12 through user interface 16, preferably at various locations throughout retail store 14. User interface 16 can take many forms, such as a simple keypad, an LED display or a PC with a display, keyboard, mouse, camera and microphone, touch screen monitor, or the like. Through communications link 12 provided to user interface 16, the customer can interact with a live manufacturer's representative through manufacturer's representative interface 20. A customer at user interface 16 can receive audio and video information from a representative at manufacturer's representative interface 20 related to questions the customer may have about a particular product or group of products. If user interface 16 is so equipped, the customer may receive printed information as prompted by the representative at manufacturer's representative interface 20.

The representative at manufacturer's representative interface 20 has access to an interface capable of sending information to user interface 16. For example, the representative can consolidate and send product information to user interface 16, and modify the information present at user interface 16 in response to queries or instructions from the customer. The information can be consolidated through various well known techniques, such as database queries, searches or selection of specific product information.

The customer can also provide information to the representative. User interface 16 provides an input mechanism, such as a keyboard or touch screen for example, which permits the customer to enter various data. For example, the customer can enter a question related to a particular product or group of products. The customer can also respond to questions or comments made by the various marketing entities. In addition, the customer can provide personal information, preference information and/or demographic information which can be used by the representative or the manufacturer 18. Any of these marketing entities may provide the customer with rewards such as promotional items or discounts for supplying such personal information, or pricing to consummate a sale.

The location of the customer need not be specific with regard to operation of system 10. That is, the customer can be at one of various user interfaces 16 located throughout a retail store or at throughout a plurality of retail stores. Accordingly, the customer can access product and service information at retail store 14, with or without the assistance of store personnel.

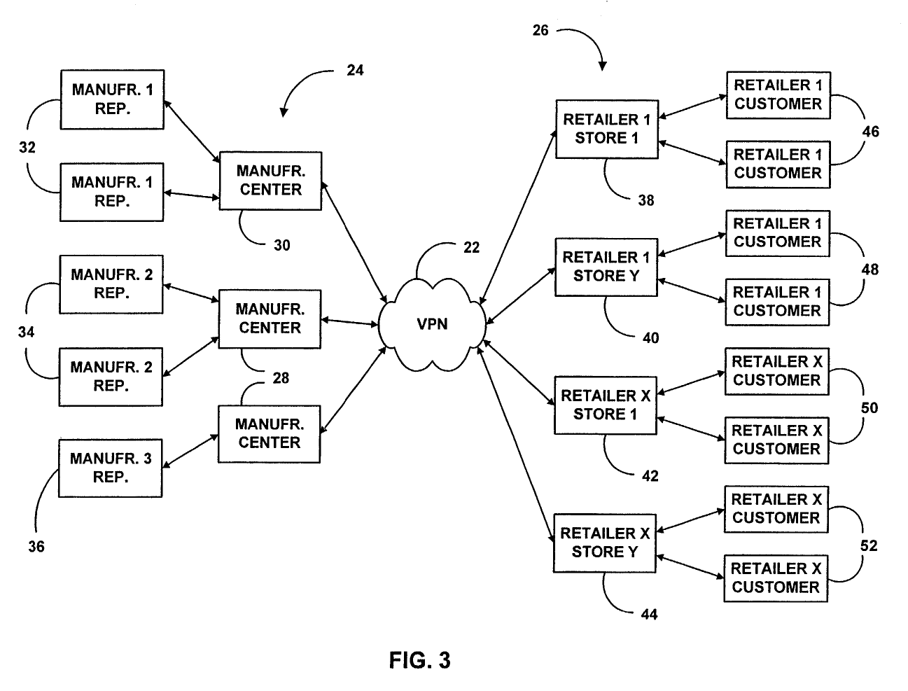

Referring now to FIG. 3, system 10 is shown using a virtual private network (VPN) 22. VPN 22 permits communication only with authorized members of the network, such as manufacturers 24 and retailers 26. As shown in FIG. 3, representatives associated with various manufacturers access VPN 22 through manufacturer centers 28 and 30. Manufacturers 24 are representative of marketing entities in general, such manufacturers or distributors. Representatives 32, 34 and 36 of manufacturers 24 are available to retailers through network connections to manufacturer centers 28 and 30 and VPN 22.

Manufacturers 24 typically offer products or services at a number of retailers 26, as illustrated by retail stores 38, 40, 42 and 44. Manufacturer 1 supplies retailer 1, having retail stores 38 and 40, with products and services that are offered for sale to customers 46 and 48, for example. Manufacturer 1 may also have an account at retailer X, to offer products and services at retail stores 42 and 44. Customers 50 and 52 of retailer X can visit retail stores 42 and 44 to obtain products and services offered by manufacturer 1.

According to the present invention, customer 46 shopping at retail store 38 belonging to retailer 1 can obtain access to VPN 22 and connect with manufacturer's representatives 32 through manufacturer center 30. Manufacturer's representatives 32 and customer 46 can then engage in a live real-time interchange to provide customer 46 with product and service information, demonstrations and other information. Customer 46 can also provide specific information to manufacturer's representatives 32 to help custom tailor a solution to the needs of customer 46. When customer 46 provides manufacturer's representatives 32 with personal information and preferences, manufacturer 1 can provide customer 46 with even more specific custom-tailored information. In addition, manufacturer 1 can include customer 46 in a sales or promotion campaign that is ongoing, or contemplated for future offerings. Customer 46 can also be offered various promotions and discounts on the spot to encourage customer 46 to purchase a product or a service from manufacturer 1 rather than manufacturers 2 or 3, for example, especially at that moment.

Manufacturers 2 and 3 also offer products and services at retail stores 38, 40, 42 and 44. Accordingly, customer 46 can obtain information about products and services offered by manufacturers 2 and 3 through manufacturer's representatives 34 and 36 connected to VPN 22 and manufacturer centers 28. With access to each of manufacturer's representatives 32, 34 and 36, customer 46 can immediately compare manufacturer specific criteria, such as price, availability, quality and so forth. Although interaction between manufacturers and customers occurs through VPN 22, only a specific number of manufacturers having access to VPN 22 can participate in supplying information to customer 46.

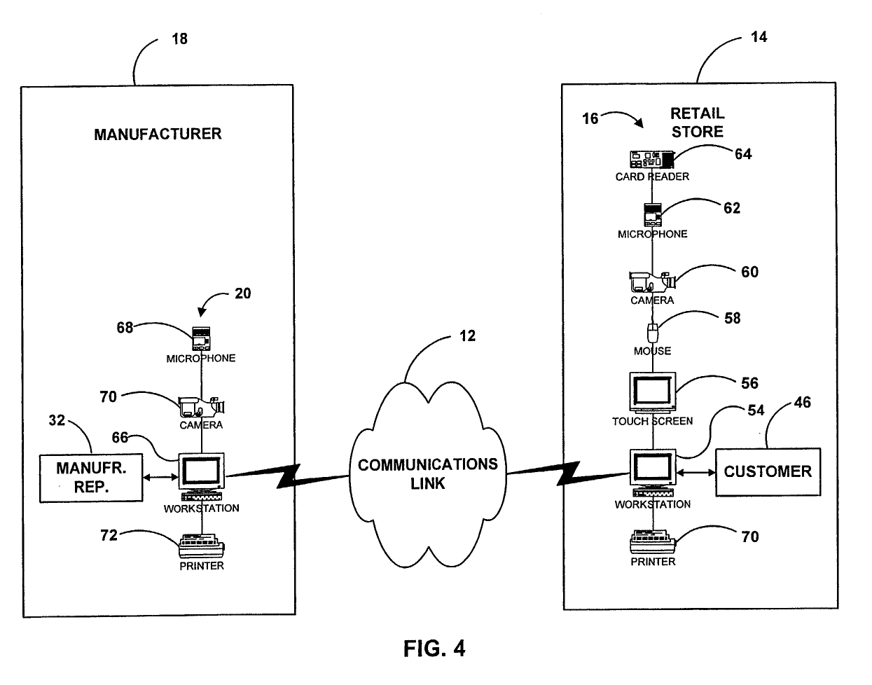

Referring now to FIG. 4, various media devices are shown that support interchanges between customer 46 and a manufacturer's representative 32. FIG. 4 shows user interface 16 found at a specific location within retail store 14. User interface 16 may include, for example, a workstation 54, a touch screen 56, a mouse 58, a camera 60, a microphone 62, and a card reader 64. Each of these components comprising user interface 16 can input or output information to customer 46 in various media formats. For example, workstation 54 can include a speaker that acts in conjunction with microphone 62 to permit customer 46 to have a conversation with manufacturer's representative 32. Workstation 54 similarly has a display that can operate in conjunction with camera 60 to permit customer 46 to send and receive video images prompted by manufacturer's representative 32. For example, the display on workstation 54 can be connected to a camera 60 to permit customer 46 to view an image of manufacturer's representative 32. In addition, manufacturer's representative 32 may display to customer 46 pictures of a product of interest, video clips, audio clips, or the like. Similarly, manufacturer's representative 32 may view image of customer 46 taken by camera 60 and sent to the display on workstation 66 of manufacturer's representative interface 20. Customer 46 and manufacturer's representative 32 can have a multimedia interchange to enhance the quantity and quality of information provided to customer 46.

Manufacturer's representative 32 can also cause display information to be sent to workstation 54 for review by customer 46, while engaging customer 46 in conversation through microphones 62, 68 and speakers in workstations 54, 66. Customer 46 can optionally print out display information on a printer 70 attached to workstation 54. For example, manufacturer's representative 32 can cause a form related to registration or warranty information for a particular product or service to be sent to workstation 54, which customer 46 can print on printer 70, complete and submit to manufacturer 18. Customer 46 can also use input devices such as touch screen 56 or card reader 64 to provide information to manufacturer's representative 32.

Manufacturer's representative 32 can cause the information entered by the customer 46 to be routed through communications link 12 to any particular site which manufacturer's representative 32 is permitted to access. For example, if customer 46 has a magnetic strip card or other portable storage device supplied by a specific retailer, which can be read in card reader 64, customer 46 can swipe the card through card reader 64 to provide manufacturer's representative 32 with, for instance, account information. Manufacturer's representative 32 can review account information and offer customer 46 various promotions or discounts based on historical account activity, or other criteria related to the account information.

By benefit of this interaction, customer 46 can obtain product specific information, can obtain answers to queries, and can be supplied with various alternatives for products and services that will meet the needs of customer 46. While FIG. 4 illustrates the connectivity involved with manufacturer's representative 32, it should be understood that a number of manufacturer's representatives are accessible by customer 46 through communication link 12. Customer 46 can at a single location obtain live competitive information regarding products and services supplied by various manufacturers 18. User preferences can also be tracked, and customer 46 can be notified of upcoming promotions or sales for which customer 46 may have an interest.

Multimedia interaction between customer 46 and manufacturer's representative 32 can take place using a number of existing technologies. For example, customer 46 and manufacturer's representative 32 can engage in textbased live chat. With this technology, customer 46 and manufacturer's representative 32 view the same information at the same time, while additions to the information in the form of text are made in real-time by customer 46 and manufacturer's representative 32. If the text-based live chat is provided on a computer capable of supplying windowed displays, the user can receive video and graphic information at the same time that they are engaging in text-based live chat.

Another media technology form available for use in system 10 is voice over IP. As illustrated in FIG. 4 customer 46 and manufacturer's representative 32 each are provided with speakers in workstations 54, 66, and microphones 62, 68. Audio signals provided by microphones 62, 68 to workstations 54, 66 are converted into digital data, which is transferred between workstations 54, 66 with LP packets over communications link 12. Again, presuming the transfer rates between workstations 54, 66 is sufficiently high, and workstations 54, 66 are capable of multitasking multimedia information, customer 46 and manufacturer's representative 32 can have a conversation using voice over IP, while also sending and receiving video, graphic or text information. If so desirable, manufacturer's representative interface 20 may also be provided with a camera 70 to enable live video transfer, and a printer 72 so that information supplied by customer 46 may be printed.

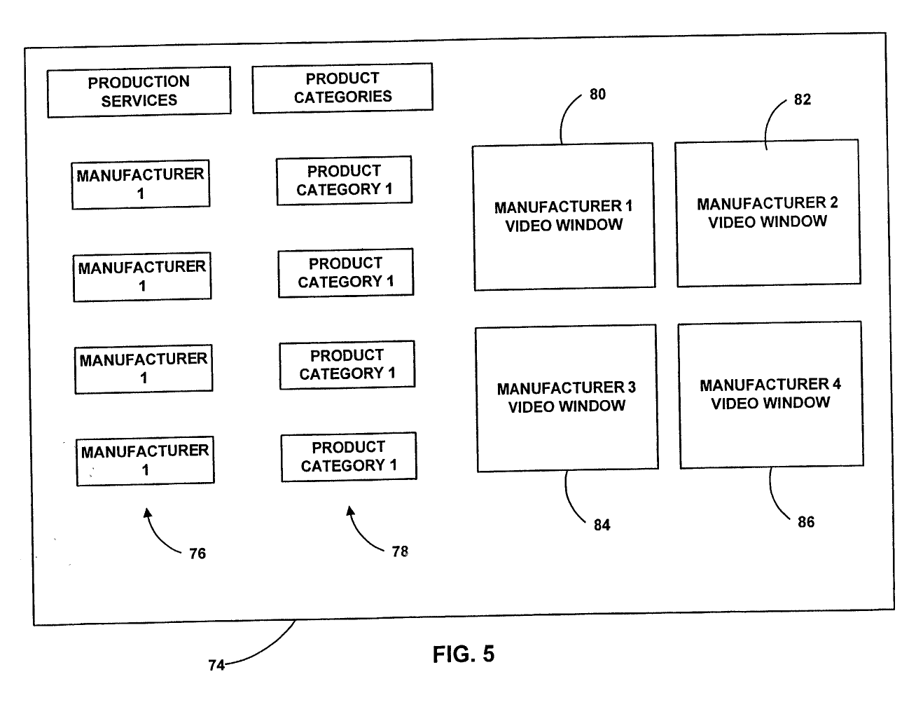

Referring now to FIG. 5, a user interface display 74 is shown. Display 74 provides the user with various selections with regard to manufacturers and products and services provided by the manufacturers. Customers can select various manufacturers from a manufacturer list 76, and various products from a product list 78 to prompt an interaction with manufacturer's representative 32, for example. Display 74 optionally has video windows 80, 82, 84 and 86. Video information can be sent to, for example, video window 80 from manufacturer's representative 32 selected from manufacturer list 76. Once customer 46 and manufacturer's representative 32 are interactively engaged, customer 46 can indicate a desire to learn more about a product by making a selection in product list 78. The selection is communicated to manufacturer's representative 32, who can then forward appropriate information to the customer 46. The information forwarded to customer 46 can be displayed in video window 80, for instance.

User interface 74 can be used in conjunction with other media forms, such as audio transmission and reception systems, as discussed above. In addition, multiple manufacturers can provide information to customer 46 at the same time through the use of, for example, video window 80, 82, 84 or 86. Accordingly, display 74 permits customer 46 to control interaction between the various manufacturers' representatives, which customer 46 can select or deselect as desired. Display 74 provided as a part of user interface 16, for example, permits the direct selection of a target manufacturer for video conferencing while located at a point of purchase. As described above, customer 46 need not be located in, for instance, retail store 14, to be at a point of purchase. For example, customer 46 accessing user interface 16 can be located at a trade show where services can be contracted, which would actually serve as the point of purchase.

In addition, system 10 can take advantage of the flexibility offered by new technology, such as touch screens, mobile communications, and high speed video imaging. For example, customer 46 may contact a manufacturer using system 10 to see if a particular product is on back order, or available in a different model preferred by customer 46. Manufacturer's representative 32 can provide customer 46 with verification of product inventory, or send an image of the particular product in the model type preferred by customer 46. Customer 46 or manufacturer's representative 32 can also take advantage of electronic communication conventions such as electronic mail or instant messaging to obtain information from other individuals on a rapid basis with regard to products or services offered by the manufacturer.

Referring again to FIG. 2, user interface 16 can be used to provide in-store training for staff members of retail store 14. For example, various staff members of retail store 14 can be made knowledgeable on the features offered by a number of products and services supplied by manufacturer 18. In store staff personnel can use the supplied training to assist customers in selecting desired products and services using system 10.

Staff personnel in retail store 14, for example, can also be trained on the use of system 10 by manufacturer's representative 32. Because system 10 is a multimedia capable system, staff personnel can be instructed through one media format, while being trained to use another. For instance, staff personnel can be trained to set up and adjust a video input, with audio instructions from manufacturer's representative 32. Once the staff personnel of retail store 14 have been trained to use system 10, they can assist customers in use of the system. Accordingly, system 10 provides an intrinsic ability to train individuals on how to use the system itself.

System 10 improves competition between manufacturers, distributors and retailers by offering consumers immediate competitive choices at a point of purchase. The consumer, or customer, is provided information with regard to a variety of products and services, from a variety of manufacturers to obtain the best product or service fit for the customer's needs at the point of purchase. System 10 can further be used to collect sales and marketing data, for use as feedback to, for instance, consumer groups, manufacturers or industry analysts. System 10 can also be the focal point of in store promotions without having the expense and resource intensive drawbacks of having, for example, a live representative present at a retailer to interact with customers.

The present invention, therefore, provides a system and method for improving marketing support which is located at the point of purchase, which is simple to use, which can deliver specific information chosen by a customer, which delivers desired information promptly to the customer, which provide for interaction between the manufacturer and customer, which can be used to collect demographic information from the customer, which is relatively inexpensive and efficient, and which can provide information relating to a plurality of manufacturers' products.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for customer and manufacturer interaction, comprising:
a customer interface connected to a network;
a plurality of manufacturer interfaces connected to said network and accessible by said customer interface, a plurality of manufacturer's representatives representing a plurality of manufacturers available at said manufacturer interfaces;
said customer interface and said manufacturer interface being operable to exchange information on a real-time basis, whereby live interaction between the customer and the plurality of manufacturers is provided; and
said customer interface being located at a point of purchase for at least one of a good and a service provided by the plurality of manufacturers.

2. A system according to claim 1, wherein said customer interface and said manufacturer interface are operable to exchange information through a plurality of input and output devices.

3. A system according to claim 1, wherein said point of purchase is a retail location offering said at least one of a good and a service.

4. A system according to claim 1, wherein said customer interface and said manufacturer interface are operable to exchange information in a plurality of media types.

5. A system according to claim 4, wherein said media types include at least one of audio, graphical, video and textual media formats.

6. A system according to claim 1, wherein said manufacturer's representatives provide information to said customer interface thereby presenting said customer with targeted information.

7. A system according to claim 6, wherein said manufacturer's representative receives information from said customer interface thereby providing said manufacturer with demographic information and allowing said manufacturer's representative to customize the information provided to said customer.

8. A system according to claim 1, wherein said customer can select at least one of manufacturer and product information via said customer interface.

9. A system according to claim 1, wherein said network is a world-wide network of interconnected computers.

10. A system according to claim 1, wherein said network is a local area network of interconnected computers.

11. A system according to claim 1, wherein said network is a wide area network of interconnected computers.

12. A system according to claim 1, wherein said network is a virtual private network of interconnected computers.

13. A system according to claim 1, wherein said network is accessible only by a set of specified manufacturers and a set of specified retailers.

14. A system according to claim 1, wherein said point of purchase is a location remote from a retail location.

15. A method for permitting a customer and a manufacturer to interact, said method comprising the steps of:
connecting a customer interface to a network, said customer interface being located at a point of purchase accessible by a shopper;
connecting a plurality of manufacturer interfaces to said network, the plurality of manufacturer interfaces being accessible by a plurality of manufacturer's representatives representing a plurality of manufacturers; and
establishing a communication link between said shopper and said manufacturer's representatives, thereby permitting said shopper and said manufacturer's representatives to interact in real-time through said customer interface and said plurality of manufacturer interfaces, whereby said shopper and said manufacturer's representatives can exchange information related to at least one of a good and a service.

16. A method according to claim 15, wherein said plurality of interfaces are operable to exchange information through a plurality of input and output devices.

17. A method according to claim 15, wherein said point of purchase is a retail location offering said at least one of a good and a service.

18. A method according to claim 15, wherein said plurality of interfaces are operable to exchange information in a plurality of media types.

19. A method according to claim 18, wherein said media types include at least one of audio, graphical, video and textual media formats.

20. A method according to claim 15, wherein a manufacturer's representative is available at said manufacturer interface, and further comprising the step of said manufacturer's representative providing information to said customer interface thereby presenting said customer with targeted information.

21. A method according to claim 20, further comprising the step of said manufacturer's representative receiving information from said customer interface thereby providing said manufacturer with demographic information and allowing said manufacturer's representative to customize the information provided to said customer.

22. A method according to claim 15, further comprising the step of said customer selecting at least one of manufacturer and product information via said customer interface.

23. A method according to claim 15, wherein said network is a world-wide network of interconnected computers.

24. A method according to claim 15, wherein said network is a local area network of interconnected computers.

25. A method according to claim 15, wherein said network is a wide area network of interconnected computers.

26. A method according to claim 15, wherein said network is a virtual private network of interconnected computers.

27. A method according to claim 15, wherein said network is accessible only by a set of specified manufacturers and a set of specified retailers.

28. A method according to claim 15, wherein said point of purchase is a location remote from a retail location.

29. A system for customer and manufacturer interaction, comprising:
a customer interface connected to a network, said customer interface being located at a point of purchase for a good or service provided by said manufacturer;
a manufacturer interface connected to said network;
software executing on said customer interface for receiving an indication from said customer of a good or service category of interest, and for displaying a list of manufacturers offering goods or services within the good or service category of interest; and
software executing on said customer interface for receiving an indication from said customer of at least one manufacturer of interest, and for establishing a realtime communication link between said customer interface and said manufacturer interface of the selected manufacturer.

30. A system according to claim 29, further comprising software executing on said customer interface for receiving an indication of customer preferences, and for customizing the list of manufacturers based upon the indication of customer preferences.

31. A system according to claim 29, wherein:
a manufacturer's representative is available at said manufacturer interface; and
said manufacturer's representative provides information to said customer interface thereby presenting said customer with targeted information.

32. A system according to claim 31, wherein said manufacturer's representative receives information from said customer interface thereby providing said manufacturer with demographic information and allowing said manufacturer's representative to customize the information provided to said customer.

33. A method for customer and manufacturer interaction comprising the steps of:
providing a customer interface connected to a network, said customer interface being located at a point of purchase for a good or service provided by said manufacturer;
providing a manufacturer interface connected to said network;
receiving an indication from said customer of a good or service category of interest;
displaying a list of manufacturers offering goods or services within the good or service category of interest;
receiving an indication from said customer of at least one manufacturer of interest; and
establishing a real-time communication link between said customer interface and said manufacturer interface of the selected manufacturer.

34. A method according to claim 33, further comprising the steps of:
receiving an indication of customer preferences; and
customizing the list of manufacturers based upon the indication of customer preferences.

35. A method according to claim 33, wherein a manufacturer's representative is available at said manufacturer interface, and further comprising the step of said manufacturer's representative providing information to said customer interface thereby presenting said customer with targeted information.

36. A system according to claim 35, further comprising the step of said manufacturer's representative receiving information from said customer interface thereby providing said manufacturer with demographic information and allowing said manufacturer's representative to customize the information provided to said customer.
